(19) United States
(12) Patent Application Publication
(10) Pub. No.: US 2025/0021928 A1
(43) Pub. Date: Jan. 16, 2025

(54) CARRIER SELECTION EFFICIENCY ANALYZERS

(71) Applicant: MANAGED TRANSPORTATION ANALYTICS LTD., Mississauga (CA)

(72) Inventors: Jon Paul GORALEWSKI, Mississauga (CA); Lawrence Joseph LECKIE, Brampton (CA)

(73) Assignee: MANAGED TRANSPORTATION ANALYTICS LTD., Mississauga, ON (CA)

(21) Appl. No.: 18/713,359

(22) PCT Filed: Nov. 24, 2022
(86) PCT No.: PCT/IB2022/061405

§ 371 Date: May 24, 2024

Related U.S. Application Data
(60) Provisional application No. 63/264,596, filed on Nov. 26, 2021.

(51) Int. Cl. G06Q 10/0834

(52) U.S. Cl. CPC G06Q 10/08345

(57) ABSTRACT

An example of an apparatus to retrieve data records to generate an index representing carrier selection efficiency is provided. The apparatus includes a communications interface to receive invoice data from a plurality of external sources. The apparatus also includes a memory storage unit to store the invoice data and pricing data. Furthermore, the apparatus includes a normalization engine to normalize the invoice data in a standardized invoice format, and to normalize the pricing data in a standardized pricing format. The apparatus further includes a reference engine to determine a reference price. In addition, the apparatus includes an analysis engine to calculate an index based on the reference price associated with each invoice of the plurality of invoices and an actual price associated with each invoice of the plurality of invoices. The index is to be transmitted to an external device.

### BACKGROUND

Third party carriers are often used to ship products and goods from one location to another. For example, products may be shipped from a business to a final consumer. In other examples, goods, such as raw materials, parts, or other items used in the manufacturing of products, may be shipped from a supplier to the business for assembly. Furthermore, for some businesses without the capability of real time pricing data feeds from third party carriers, the selection of third party carriers is generally carried out by managers or other employees based on human judgement.

### SUMMARY

In accordance with an aspect of the invention, there is provided an apparatus. The apparatus includes a communications interface to receive invoice data from a plurality of external sources. The invoice data includes data that may represent a plurality of invoices, which may include shipping data, associated with the external sources. In addition, the apparatus includes a memory storage unit to store the invoice data, shipping data, and pricing data. The pricing data represents rate agreements associated with the external sources. Furthermore, the apparatus includes a normalization engine to normalize the invoice data in a standardized invoice format, and to normalize the pricing data in a standardized pricing format. The apparatus also includes a reference engine to determine a reference price associated with each invoice of the plurality of invoices based on the pricing data in the standardized pricing format. The apparatus additionally includes an analysis engine to generate an index based on the reference price associated with each invoice of the plurality of invoices and an actual price associated with each invoice of the plurality of invoices. The index may be transmitted to an external device.

The pricing data may include information from pricing agreements. The reference price may be based on a quality standard.

The apparatus may include a selection engine to select a set of invoices from the plurality of invoices. The selection engine may receive input to select the set of invoices from the plurality of invoices. The selection engine may automatically select the set of invoices from the plurality of invoices based on a predetermined parameter.

The communications interface may be used to transmit a command based on the index. The apparatus may include a rendering engine to generate output to a display based on the index.

In accordance with an aspect of the invention, there is provided a method involving receiving invoice data from a plurality of external sources. The invoice data represents a plurality of invoices associated with the external sources. The method further involves storing the invoice data in a memory storage unit. In addition, the method involves normalizing the invoice data in a standardized invoice format. The method also involves normalizing pricing data in a standardized pricing format. The pricing data represents rate agreements associated with the external sources. Furthermore, the method involves determining a reference price associated with each invoice of the plurality of invoices based on the pricing data in the standardized format. The method also involves calculating an index based on the reference price associated with each invoice of the plurality of invoices and an actual price associated with each invoice of the plurality of invoices. The actual price is extracted from the invoice data in the standardized invoice format. The index is to be transmitted to an external device.

### BRIEF DESCRIPTION OF THE DRAWINGS

Reference will now be made, by way of example only, to the accompanying drawings in which:

FIG. 1 is a block diagram of an example apparatus to retrieve data records to generate an index representing carrier selection efficiency;

FIG. 2 is a diagram of an example system to generate an index representing carrier selection efficiency using the apparatus shown in FIG. 1;

FIG. 3 is a block diagram of another example apparatus to retrieve data records to generate an index representing carrier selection efficiency; and

FIG. 4 is a flowchart of an example method of generating an index representing carrier selection efficiency.

### DETAILED DESCRIPTION

The use of third party carriers may be a significant expense for businesses where goods and products are shipped from one location to another. Although there exist real time systems to monitor shipping rates from each carrier for a specific shipment, the systems are expensive and cost-prohibitive for many businesses. Further, these systems typically have their own limitations that may inadvertently lead to non-optimal results. Accordingly, such businesses generally aim to select carriers based on general rules or the knowledge of a person. However, the costs for each shipment varies on many factors such as fuel surcharges, oversize surcharges, special handling surcharges, destination charges, currency exchange rates, residential surcharges, peak season surcharges, number of pieces, discounts that can change weekly based on prior weeks' average volumes, etc. It is to be appreciated by a person of skill with the benefit of this description that carriers may adjust or modify rate agreements from time to time to add additional charges or to modify the rate thresholds for each charge. Accordingly, the ability to monitor the effectiveness of any cost management program is based on general rules in an environment where both internal and external factors constantly change the various fees added to a shipment is limited without the use of expensive real time fee estimation systems.

To control and monitor costs, various metrics may be collected and used to analyze and estimate costs of shipping associated with the normal operation of a business. The estimates are generally carried out by consultants who collect the metrics, such as determining the number of shipments over a period of time, the number of pieces shipped over a period of time, the number of pieces in each shipment, the weight of each shipment or piece, the total cost paid to carriers over a period of time, the total cost paid to carriers per shipment, or the total cost paid to carriers per unit of weight. The consultant then performs an analysis based on the consultant's expertise and subjective views to provide estimates and identify areas where costs can be reduced by changing a shipping behavior. However, it is to be appreciated by a person of skill with the benefit of this description that the metrics are static and do not change. Accordingly, if the business changes, such as the service level requested, the geographical distribution of the goods, the size and quantity of the goods, or the introduction of new surcharges by the carriers, the estimates based on the metrics may no longer be accurate.

An apparatus and associated method to retrieve data records received from multiple sources in multiple formats to generate an index representing an efficiency is provided. In the present example, the data records may represent actual invoices and pricing data, which outlines how pricing is determined for each shipment. The data records may then be normalized to extract the relevant information and compared to generate reference prices, which can be compared with actual prices to calculate the index. Once calculated, the index can be transmitted to an external device for further action, or the apparatus may automatically take action such as updating a policy or rules to be followed for subsequent shipping.

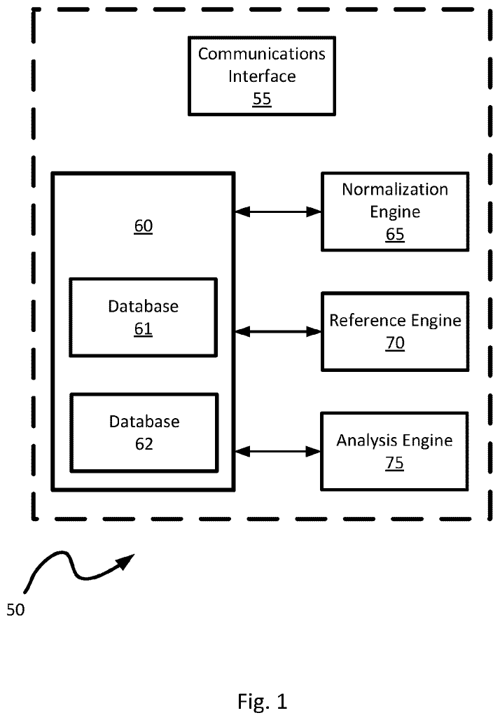

Referring to FIG. 1, a schematic representation of an example of the components of an apparatus to retrieve data records to generate an index representing carrier selection efficiency is generally shown at 50. The apparatus 50 may include additional components, such as various memory storage units, additional interfaces to communicate with other devices, and further input and output devices to interact with a user or an administrator of the apparatus 50. In addition, the apparatus 50 may be separated into multiple components operating as a system as described in greater detail below. In some examples, the components may be distributed across multiple locations and operate as a cloud service. In the present example, the apparatus 50 includes a communications interface 55, a memory storage unit 60, a normalization engine 65, a reference engine 70 and an analysis engine 75. Although the present example shows the normalization engine 65, the reference engine 70, and the analysis engine 75 as separate components, in other examples, the normalization engine 65, the reference engine 70, and the analysis engine 75 may be part of the same physical component, such as a microprocessor configured to carry out multiple functions.

The communications interface 55 is to communicate with other devices or services over a network. In particular, the communications interface 55 is to receive invoice data from a plurality of external sources. The invoice data is not particularly limited and may include data associated with invoices from each of the external sources. For example, the invoice data may include actual invoices, shipping reports, carrier billing reports, shipping system manifests, and other similar documents. In the present example, an external source may be a carrier used to ship items, such as goods or supplies used in the manufacture of goods. Businesses that ship goods generally use multiple carriers to diversify providers such that if there are delays or other issues with a carrier, alternatives are available.

The manner by which the communications interface 55 connects the external sources to the apparatus 50 is not limited and may include different types of networks, such as a wired or wireless local network. Furthermore, it is to be appreciated by a person of skill with the benefit of this description that the communications interface 55 may be configured to receive other types of data as well, such as pricing data from the external sources or from a central storage system, such as a file server that stores pricing data from each carrier. In the present examples, pricing data may represent rate agreements from which the cost of shipping a package using the carrier associated with the external source 30 can be determined. In other examples, it is to be appreciated that the pricing data may provide instructions based on information from pricing agreements to calculate actual prices based on real time shipping information. The real time shipping information may not be readily available at the time of shipping. For example, the pricing data may involve calculations based on factors, such as fuel surcharges, oversize surcharges, special handling surcharges, destination charges, currency exchange rates, residential surcharges, peak season surcharges, number of pieces, discounts that can change weekly based on prior weeks' average volumes, etc.

In addition, it is to be appreciated by a person of skill in the art that the pricing data may include other information affecting the cost of delivering goods. For example, the pricing data may include costs associated with delivering goods to an end recipient that may involve multiple carriers. The carriers may include line haul services between warehouses in combination with last mile delivery fees. Accordingly, the pricing data may provide for a comparison between the cost of moving goods from a manufacturer in bulk to multiple warehouses close to the end recipient and the cost of moving goods directly from the manufacturer to each end recipient by including information obtained from multiple sources.

In the present example, the memory storage unit 60 is to store various data and information on the apparatus 50. The memory storage unit 60 is not particularly limited and may include various types of computer memory devices. For example, the memory storage unit 60 may include a non-transitory machine-readable storage medium that may be, for example, an electronic, magnetic, optical, or other physical storage device. In other examples, the memory storage unit 60 may be an external unit, such as an external hard drive, or a cloud service providing content. In the present example, the memory storage unit 60 is to store invoice data in a database 61 and pricing data in another database 62.

The normalization engine 65 is to normalize the data records in the database 61 and the database 62. In the present example, each data record in the database 61 may represent an invoice for a shipment in a format determined by the carrier. Similarly, each data record in the database 62 may represent a rate agreement entered into with the carrier specific to the business. Accordingly, the format in which the information is presented from each carrier may be different such that it cannot be directly compared or aggregated to generate any statistics.

The manner by which the data records in the database 61 and the database 62 are normalized by the normalization engine 65 is not particularly limited. In the present example, the data records in the database 61 and the database 62 are scanned to extract relevant information to create a standardized data record to be stored in the memory storage unit 60. The format of the standardized data record is not particularly limited and may be in a format unique to the business or may be in a format of one of a frequently used carrier. It is to be appreciated by a person of skill with the benefit of this description that if a format is that of a frequently used carrier, the normalization engine 65 may skip some data records to reduce the amount of processing to be carried out.

The standardized data record is to be stored in separate databases on the memory storage unit 60. In the present example, each standardized format of the invoice data may include a field that stores an identifier of the carrier and a field to store the breakdown of costs charged by the carrier. For example, separate fields may be used to store the base cost, fuel surcharges, taxes, and other charges on an invoice. The standardized format of the pricing data may include a field that stores an identifier of the carrier, and a field to store the surcharges along with rules relating to when a surcharge is to be applied and the manner by which the surcharge is to be determined. The normalization engine 65 may further be used to group data from multiple data records from the database 61. For each data record from the database 61, the normalization engine 65 will normalize the data record. The normalization engine 65 may match sales agent identifiers in the normalized pricing data to generate a single standardized data record for each sales agent.

The reference engine 70 is to use the normalized pricing data generated to determine a reference price associated with each invoice data record in the database 61. The manner by which the reference engine 70 determines the reference price is not particularly limited. In the present example, the reference engine 70 retrieves data records of the invoice data in the standardized format to obtain the shipment details. The reference engine 70 uses the shipment details to calculate a total price based on the normalized pricing data for each carrier. Since the reference engine 70 calculates prices based on actual historical shipments that have been shipped and invoiced, the historical data affecting the variable costs is generally available and can be used to calculate the total price for each carrier accurately.

Upon calculating the total price for each carrier, the reference price for the shipment may be selected. The manner by which the reference price is selected is not particularly limited. In the present example, the reference price may be the lowest price for transporting the shipment from the origin to the destination provided in the data record of the invoice data. In other examples, the reference price may also be based on additional factors such as quality standards. For example, the reference price selection process may exclude certain routes for the shipment or exclude carriers that cannot deliver the shipment within a target timeline.

The analysis engine 75 is to generate or calculate an index based on a comparison of the reference price for each invoice as determined by the reference engine 70 and the actual price paid for the shipment based on the invoice data. The index is not particularly limited and generally used as an indication of the efficiency of a shipping practice across a set of data. In the present example, the set of data represents shipments made by a business across a period of time and the index value is correlated to the difference between what was actually spent on carrier services compared with the reference price for similar services that may have achieved similar business objectives. Accordingly, an index value close to zero may suggest that the business is shipping packages as cost efficiently as possible. In other examples, the index value may be a ratio of the amount actually spent on carrier services and other related shipping costs to the reference price where the goal may be to seek an index value closer to about one.

In some examples, the apparatus 50 may include a selection engine to select a subset of data, such as a set of invoices, from which the index is to be calculated. The manner by which the selection engine makes the selection is not particularly limited. In some examples, the selection engine may receive input to select or filter invoices based on a time period, origin location, destination location, etc. to generate an index to examine the efficiency of an isolated portion of shipments. In other examples, the selection engine may automatically select a subset of data based on predetermined parameters, such as a location which is subject to a periodic review.

Upon generating the index, the apparatus 50 may be configured to carry out follow-up actions. For example, the apparatus 50 may transmit, via the communications interface 55, a command to another system to update shipping policies, such as to update an approved carrier list. In other examples, the apparatus 50 may transmit, via the communications interface 55, the index value to an external device requesting the index value to be used to carry out follow-up actions. In further examples, the apparatus 50 may include a display to which the index may be rendered.

Various advantages will now be apparent to a person of skill in the art with the benefit of the present description. For example, the index provides a simple-to-understand metric by which the shipping policies of a company can be measured. In addition, changes to any policies may also be monitored to determine effectiveness over time. The index accounts for many aspects of the dynamism of the shipping industry without the use of costly real time cost estimate systems and allows a business to manage the choice of carrier at any granular level that is relevant. Furthermore, the apparatus 50 does not use substantial analysis of historical data and subsets of the data may be isolated to identify policies or areas where cost efficiency can be adjusted.

By using pricing data based on rate agreements, the pricing data may be amended as old carriers are removed from a list of approved carriers, new carriers are added, or carriers make adjustment to the rate agreement affecting how the reference price is to be calculated. Furthermore, although the above examples are directed to the shipping industry, it is to be appreciated by a person of skill in the art with the benefit of this description that the apparatus 50 may be applied to other industries to generate an efficiency index to monitor costs.

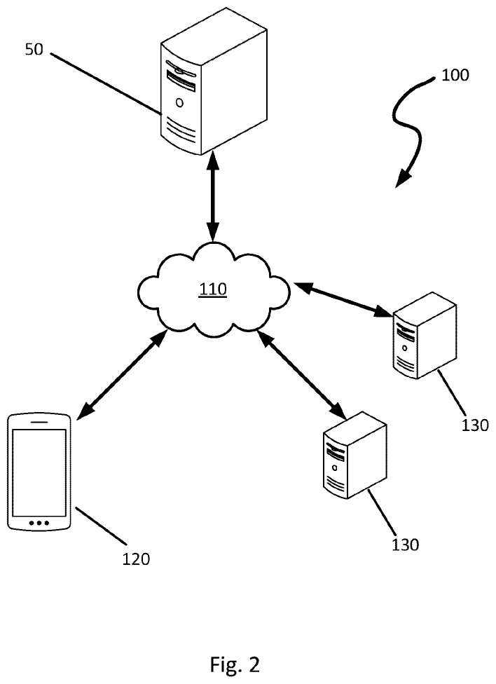

Referring to FIG. 2, an example of a system to monitor the efficiency of the use of multiple carriers to ship packages is generally shown at 100. In the present example, the apparatus 50 is in communication with an external device 120 and external sources 130 via a network 110. It is to be appreciated that the external device 120 and the external sources 130 are not particularly limited and variations capable of performing the design functions may be substituted. Furthermore, although the present example illustrates two external sources 130, additional external sources may be added to the system 100.

The external device 120 may be any type of electronic device used to request an efficiency index. Some examples of devices that may be used as an external device 120 are a smartphone, a tablet, a laptop, a desktop computer, or any other device capable of receiving user input and generating user output. The external device 120 includes its own communications interface and processor. The external device 120 may also include input, such as from a keyboard, pointer, and or touchscreen, and/or output devices such as a display or touchscreen display.

Each external source 130 may be a data source from a carrier, such as a file server, to provide invoice data and pricing data. For example, the external source 130 may send invoice data to the apparatus periodically when shipping services are to be billed. The pricing data may be sent from the external source 130 to the apparatus 50 when a relationship is formed between a business and a carrier. Pricing data may also be updated periodically to reflect pricing changes or changes to the pricing model, such as from a renegotiation of the terms of the rate agreement. It is to be appreciated by a person of skill with the benefit of this description that the manner by which data is obtained from the external source 130 is not particularly limited. In some examples, the external source 130 pushes invoice data and pricing data to the apparatus 50 from where it is to be retrieved by the external device 120 upon demand. In other examples, the external device 120 may communicate directly with the external source 130 to obtain the invoice data and pricing data.

During operation, shipping services may be provided to a business by two carriers in the present example. The business may use the apparatus 50 to monitor shipping efficiency and the carriers may each operate a server to be an external source 130. Upon agreement to a shipping contract, the external sources 130 will transmit a rate agreement in the form of pricing data to the apparatus 50. The carriers and the business then operate normally where the business uses the services of the carriers based on internal shipping policies regarding the selection of the carrier. During business operations, the apparatus 50 may collect data as the invoices are received from the external sources 130 for services rendered. At some point, a user may operate the external device 120 to request an efficiency index from the apparatus 50 to monitor the efficiency of the shipping policies that determine carrier selection.

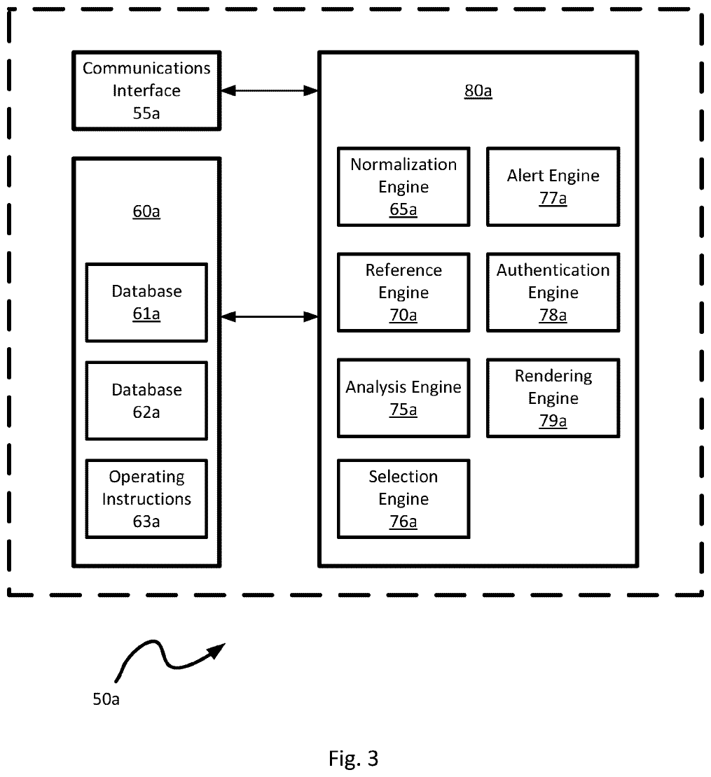

Referring to FIG. 3, another schematic representation of an example of the components of an apparatus 50a to retrieve data records to generate an index representing carrier selection efficiency is generally shown. Like components of the apparatus 50a bear like reference to their counterparts in the apparatus 50, except followed by the suffix “a”. In the present example, the apparatus 50a includes a communications interface 55a, a memory storage unit 60a, and a processor 80a.

The memory storage unit 60a is to store additional data to be used by the processor 80a as well as persistent data. For example, the memory storage unit 60a stores the database 61a and the database 62a, which are substantially similar to their counterparts discussed above. In the present example, the memory storage unit 60a also stores a database of operating instructions 63a. The operating instructions 63a are not particularly limited and may be instructions to be carried out by the processor 80a for the general operation of the apparatus 50a. In particular, the operating instructions 63a may include an operating system that is executable by a processor 80a to provide general functionality to the apparatus 50a. In some examples, the operating instructions 63a may include instructions to operate other components and peripheral devices of the apparatus 50a.

In the present example, the processor 80a may include a central processing unit, a microcontroller, a microprocessor, a processing core, a field-programmable gate array, an application-specific integrated circuit, or similar. The processor 80a may cooperate with the memory storage unit 60a to execute various instructions, such as the operating instructions 63a, stored thereon. The processor 80a is connected to the communications interface 55a and may receive data and/or send or transmit commands or data to an external device.

In the present example, the processor 80a may carry out instructions to implement various components of the apparatus 50a. For example, the processor 80a may execute instructions to carry out the functionality of a normalization engine 65a, a reference engine 70a, and an analysis engine 75a. In the present example, the processor 80a may execute further instructions to carry out the functionality of a selection engine 76a, an alert engine 77a, an authentication engine 78a, and a rendering engine 79a. In addition, the processor 80a may be programmed to transmit and receive data via the communications interface 55a and to read and write data from the memory storage unit 60a.

The selection engine 76a is to select a subset of data, such as a set of invoices, from which the index is to be calculated by the analysis engine 75a. The manner by which the selection engine 76a makes the selection is not particularly limited. In some examples, the selection engine 76a may receive input to select or filter invoices based on a time period, origin location, destination location, etc. to generate an index to examine the efficiency of an isolated portion of shipments. The input may be received via an input device, such as a keyboard, a pointer device, and/or a touchscreen. In other examples, the input may be received from another device via the communications interface 55a.

In further examples, the selection engine 76a may not select a subset of the data. Instead, the selection engine 76a may automatically select a subset of data based on predetermined parameters. The predetermined parameters are not particularly limited and may include a selection based on location, which is subject to a periodic review. Accordingly, it is to be appreciated by a person of skill with the benefit of this description that the selection engine 76a may be used to filter data in the database 61a and the database 62a to generate an index that is associated with the location.

The alert engine 77a is to generate an alert message. In the present example, the alert message is to be generated based on a predetermined threshold of the index calculated by the analysis engine 75a. The alert message generated is not particularly limited and may be any message to indicate that the predetermined threshold has been reached. For example, the alert message may be transmitted via the communications interface 55a to an external device to notify a user. The alert message may be displayed for a local user and subsequently transmitted to an external device upon being prompted by the local user. In this example, the external device may be a portable electronic device of another user, such as a supervisor. In other examples, the alert engine 77a may automatically transmit the alert message to an external device such that the apparatus 50a can operate autonomously without monitoring by a local user.

It is to be appreciated by a person of skill with the benefit of this description that the predetermined threshold for the index value may be set and modified by a user. The predetermined threshold is to be associated with an acceptable shipping practice efficiency for the set of data analyzed by the analysis engine 75a. By generating an alert message, the apparatus 50a provides an indication to a user for potential follow-up action. The follow-up action to be taken by the user is not particularly limited and may depend on various policies and decision making parameters of an organization using the apparatus 50a. For example, an index value that reaches a threshold to indicate poor performance may call for user intervention to investigate the inefficiency to avoid further loss to the organization. The intervention is not particularly limited and may involve auditing the carrier selection process.

The authentication engine 78a is to verify credentials from the external device 120. Since the index value and information associated with the index value may be considered to be proprietary information of an organization, the transmission of the index value to the external device 120 is to be secured. The manner of securing the communication is not particularly limited. For example, messages transmitted to the external device 120 may be encrypted. In other examples, login credentials may be provided by the external device 120 where the authentication engine 78a carries out a verification step to establish a secure link between the apparatus 50a and the external device 120 where data and messages, such as the index value and an alert message, may be transmitted or requested. The secure link may be established on the external device 120 via an application installed on the external device 120 in some examples.

In the present example, the rendering engine 79a is to generate output based on the index calculated by the analysis engine 75a. The manner by which the output is rendered is not particularly limited. For example, the rendering engine 79a may communicate with a display device (not shown) to generate and transmit images and video to the display device to communicate an index or other message based on the index to a user. For example, the rendering engine 79a may generate visualizations of the index along with historical values stored in the memory storage unit 60a, such as charts and graphs.

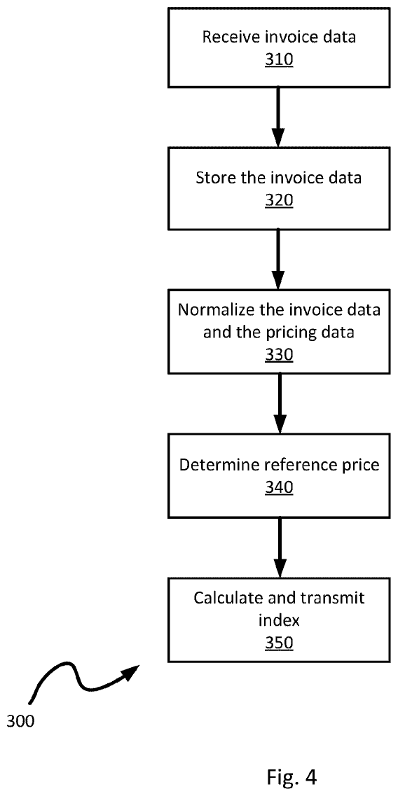

Referring to FIG. 4, a flowchart of an example method of generating an index to monitor the efficiency of the use of multiple carriers to ship packages is generally shown at 300. In order to assist in the explanation of method 300, it will be assumed that method 300 may be performed by the apparatus 50 in the system 100. Indeed, the method 300 may be one way in which the apparatus 50 may be configured. Furthermore, the following discussion of method 300 may lead to a further understanding of the system 100 and its components. In addition, it is to be emphasized that method 300 may not be performed in the exact sequence as shown, and various blocks may be performed in parallel rather than in sequence, or in a different sequence altogether.

Beginning at block 310, invoice data is received at the apparatus 50 from a plurality of external sources 130. In the present example, the invoice data is to represent a plurality of invoices associated with the external sources 130 for services rendered. The invoice data is then stored in the memory storage unit 60 of the apparatus 50 at block 320.

Next, the apparatus 50 normalizes the invoice data and the pricing data at block 330 to generate data in a standardized format. It is to be appreciated that by converting the invoice data and the pricing data into a standardized format, information from different external sources 130 may be compared in a more efficient manner. For example, the standardized format of the invoice data and the pricing data may be used to determine a reference price to be associated with each invoice at block 340.

Block 350 generates an index based on the reference price determined at block 340 for each invoice and the actual price of the invoice. It is to be appreciated by a person of skill with the benefit of this description that the actual price of each invoice may be easily extracted from the standardized format. Once the index is generated, the index may be transmitted to a requesting device for subsequent processing.

It should be recognized that features and aspects of the various examples provided above may be combined into further examples that also fall within the scope of the present disclosure.

1. An apparatus comprising:
a communications interface to receive invoice data from a plurality of external sources, wherein the invoice data represents a plurality of invoices associated with the external sources;
a memory storage unit to store the invoice data and pricing data, wherein the pricing data represents rate agreements associated with the external sources;
a normalization engine to normalize the invoice data in a standardized invoice format, and to normalize the pricing data in a standardized pricing format;
a reference engine to determine a reference price associated with each invoice of the plurality of invoices based on the pricing data in the standardized pricing format; and
an analysis engine to calculate an index based on the reference price associated with each invoice of the plurality of invoices and an actual price associated with each invoice of the plurality of invoices, wherein the index is to be transmitted to an external device.

2. The apparatus of claim 1, wherein the pricing data includes information from pricing agreements.

3. The apparatus of claim 1, wherein the reference price is based on a quality standard.

4. The apparatus of claim 1, further comprising a selection engine to select a set of invoices from the plurality of invoices.

5. The apparatus of claim 4, wherein the selection engine receives input to select the set of invoices from the plurality of invoices.

6. The apparatus of claim 4, wherein the selection engine automatically selects the set of invoices from the plurality of invoices based on a predetermined parameter.

7. The apparatus of claim 1, further comprising an alert engine to generate an alert message to be transmitted via the communications interface, wherein the alert message is generated based on a predetermined threshold of the index.

8. The apparatus of claim 7, wherein the alert message is transmitted to the external device automatically.

9. The apparatus of claim 1, further comprising an authentication engine to verify credentials from the external device.

10. The apparatus of claim 1, further comprising a rendering engine to generate output based on the index, wherein the output is to be transmitted to a display device.

11. A method comprising:
receiving invoice data from a plurality of external sources, wherein the invoice data represents a plurality of invoices associated with the external sources;
storing the invoice data in a memory storage unit;
normalizing the invoice data in a standardized invoice format;
normalizing pricing data in a standardized pricing format, wherein the pricing data represents rate agreements associated with the external sources;
determining a reference price associated with each invoice of the plurality of invoices based on the pricing data in the standardized pricing format;
calculating an index based on the reference price associated with each invoice of the plurality of invoices and an actual price associated with each invoice of the plurality of invoices, wherein the actual price is extracted from the invoice data in the standardized invoice format; and
transmitting the index to an external device.

12. The method of claim 11, further comprising selecting a set of invoices from the plurality of invoices based on a predetermined parameter.

13. The method of claim 12, further comprising receiving input to set the predetermined parameter.

14. The method of claim 11, further comprising generating an alert message based on a predetermined threshold of the index.

15. The method of claim 14, further comprising transmitting the alert message to the external device automatically.

16. The method of claim 11, further comprising receiving credentials from the external device.

17. The method of claim 16, further comprising verifying the credentials.

18. The method of claim 11, further comprising generating output based on the index, and transmitting the output to a display device.

19. A non-transitory machine-readable storage medium encoded with instructions to direct a processor to:
receive invoice data from a plurality of external sources, wherein the invoice data represents a plurality of invoices associated with the external sources;
store the invoice data in a memory storage unit;
normalize the invoice data in a standardized invoice format;
normalize pricing data in a standardized pricing format, wherein the pricing data represents rate agreements associated with the external sources;
determine a reference price associated with each invoice of the plurality of invoices based on the pricing data in the standardized pricing format;
calculate an index based on the reference price associated with each invoice of the plurality of invoices and an actual price associated with each invoice of the plurality of invoices, wherein the actual price is extracted from the invoice data in the standardized invoice format; and
transmit the index to an external device.

20-21. (canceled)

22. The non-transitory machine-readable storage medium of claim 19, wherein the instructions direct the processor to generate an alert message based on a predetermined threshold of the index, wherein the instructions direct the processor to transmit the alert message to the external device automatically.

23-26. (canceled)
